(19) United States
(12) Patent Application Publication
(10) Pub. No.: US 2009/0148032 A1
(43) Pub. Date: Jun. 11, 2009

(54) Alignment Using Moire Patterns

(75) Inventors: Philip D. Schumaker, Austin, TX (US); Tom H. Rafferty, Austin, TX (US); Niyaz Khusnatdinov, Round Rock, TX (US); Dwayne L. LaBrake, Cedar Park, TX (US)

Correspondence Address: MOLECULAR IMPRINTS, PO BOX 81536, AUSTIN, TX, 78708-1536, US

(73) Assignee: Molecular Imprints, Inc., Austin, TX (US)

(21) Appl. No.: 12/328,350

(22) Filed: Dec. 4, 2008

Related U.S. Application Data
(60) Provisional application No. 60/992,521, filed on Dec. 5, 2007.
(60) Provisional application No. 60/992,548, filed on Dec. 5, 2007.

(51) Int. Cl. G06K 9/00

(52) U.S. Cl. 382/141

(57) ABSTRACT

Methods of determining relative spatial parameters between two substrates in a process of alignment are described. Generally, multiple alignment data may be collected from phase information using a pair of alignment marks.

### CROSS REFERENCE TO RELATED APPLICATIONS

This application claims the benefit under 35 U.S.C. §119(e)(1) of U.S. Provisional No. 60/992,521 and U.S. Provisional No. 60/992,548, which are hereby incorporated by reference.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference.

An imprint lithography technique disclosed in each of the aforementioned U.S. patent publications and patent includes formation of a relief pattern in a formable layer (polymerizable) and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of a lithographic system in accordance with an embodiment of the present invention.

FIG. 2 illustrates a simplified side view of the substrate shown in FIG. 1 having a patterned layer positioned thereon.

FIG. 3 illustrates a flow chart of an exemplary method for determining displacement from a set of phase measurements of a data source having at least two frequencies.

FIG. 4 illustrates a graphical representation of phase angle change in relation to relative displacement.

FIG. 5 illustrates a graphical representation of change in delta Δ in relation to relative displacement.

FIG. 6 illustrates a graphical representation of minimization of delta Δ to provide displacement error.

FIG. 7 illustrates exemplary linear gratings having periods capable of forming a moiré pattern.

FIG. 8 illustrates exemplary linear gratings having incommensurate periods capable of forming a moiré pattern.

### DETAILED DESCRIPTION

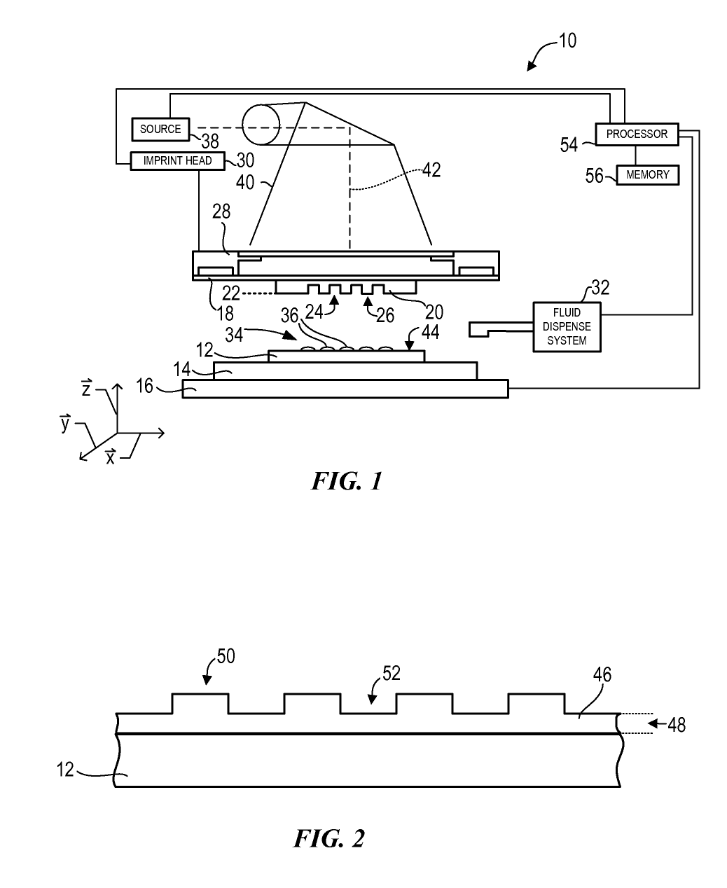

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference.

Substrate 12 and substrate chuck 14 may be further supported by stage 16. Stage 16 may provide motion along the x-, y-, and z-axes. Stage 16, substrate 12, and substrate chuck 14 may also be positioned on a base (not shown).

Spaced-apart from substrate 12 is a template 18. Template 18 may include a mesa 20 extending therefrom towards substrate 12, mesa 20 having a patterning surface 22 thereon. Further, mesa 20 may be referred to as mold 20. Alternatively, template 18 may be formed without mesa 20.

Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Exemplary chucks are further described in U.S. Pat. No. 6,873,087, which is hereby incorporated by reference. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 20 and substrate 12 depending on design considerations. Polymerizable material 34 may comprise a monomer mixture as described in U.S. Pat. No. 7,157,036 and U.S. Patent Publication No. 2005/0187339, all of which are hereby incorporated by reference.

Referring to FIGS. 1 and 2, system 10 may further comprise an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46 on substrate 12. Patterned layer 46 may comprise a residual layer 48 and a plurality of features shown as protrusions 50 and recessions 52, with protrusions 50 having thickness t₁ and residual layer having a thickness t₂.

The above-mentioned system and process may be further employed in imprint lithography processes and systems referred to in U.S. Pat. No. 6,932,934, U.S. Patent Publication No. 2004/0124566, U.S. Patent Publication No. 2004/0188381, and U.S. Patent Publication No. 2004/0211754, all of which are hereby incorporated by reference.

### Dual Pitch Moire Phase Unwrapping

Alignment between template 18 and substrate 12 may be facilitated by evaluation of moiré patterns provided by alignment marks as described in U.S. Publication No. 2004/0189996, which is hereby incorporated by reference. The presence of phase noise, camera theta, and ambiguous regions may complicate recovering absolute phase errors. There are numerous methods to unwrap, reconstruct, and/or recover phase errors within the field of interferometry and Fourier domain analysis. Algorithms, however, tend to be domain specific and generally none are applicable to alignment between templates 18 and substrates 12.

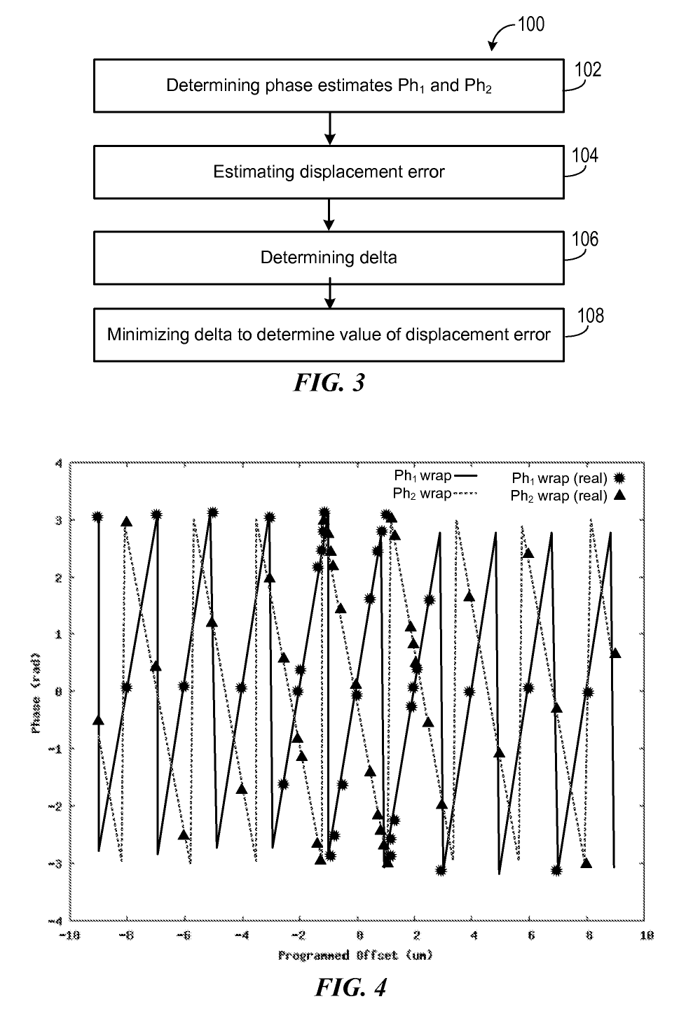

FIG. 3 illustrates a method 100 for recovering displacement from a set of phase measurements of a data source having two frequencies. In a step 102, phase estimates Ph₁ and Ph₂ may be determined by:

Ph₁=A₁+B₁ (EQ. 1)

Ph₂=−A₂+B₂ (EQ. 2)

As illustrated in FIG. 4, phase angles may change with relative displacement. In a step 104, displacement error may be estimated by:

$$E = \frac{1}{2} ( ( {Ph}_{1} \times \frac{{P}_{1}}{2 Π} ) - ( {Ph}_{2} \times \frac{{P}_{2}}{2 Π} ) ) \qquad ( EQ . 3 )$$

If the relative shift between Ph₁ and Ph₂ is at a minimum, then B₁ and B₂ may both be equal to zero and the displacement may be calculated. If the relative shift between Ph₁ and Ph₂ is greater than the period of one or both of the frequencies, then one or both of B₁ and B₂ may be non-zero. To cancel A₁ and A₂ terms, delta Δ may be determined. In a step 106, delta Δ may be determined by:

$$Δ == \frac{1}{2} ( ( {Ph}_{1} \times \frac{{P}_{1}}{2 Π} ) + ( {Ph}_{2} \times \frac{{P}_{2}}{2 Π} ) ) \qquad ( EQ . 4 )$$

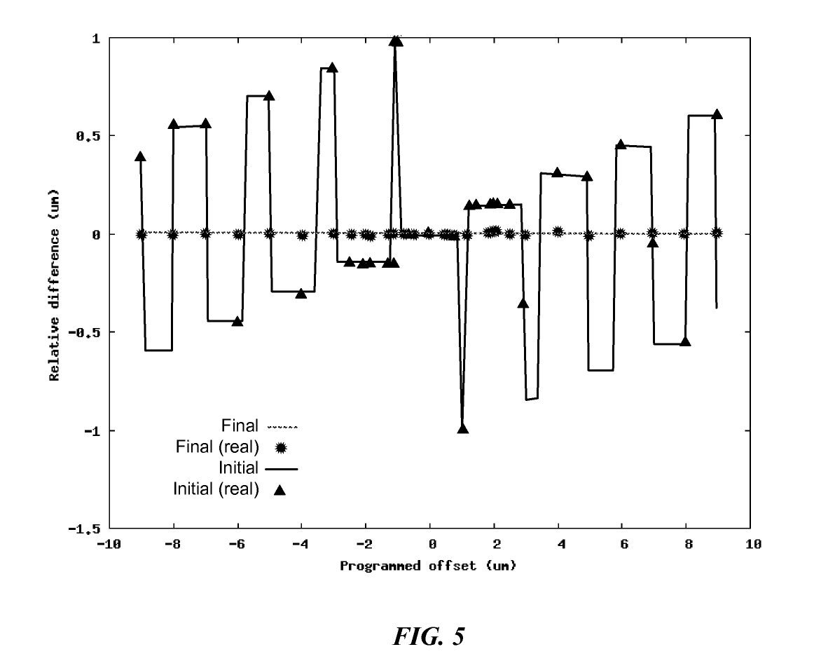

As illustrated in FIG. 5, delta Δ may change with relative displacement. In a step 108, delta Δ may be minimized. For example, delta Δ may be minimized by iteratively searching the phase wrap space to find value of n₁ and n₂ wherein:

$$\begin{matrix}{B}_{1} = ( \frac{2 Π {n}_{1}}{{P}_{1}} ) & ( EQ . 5 ) \\ {B}_{2} = ( \frac{2 Π {n}_{2}}{{P}_{2}} ) & ( EQ . 6 )\end{matrix}$$

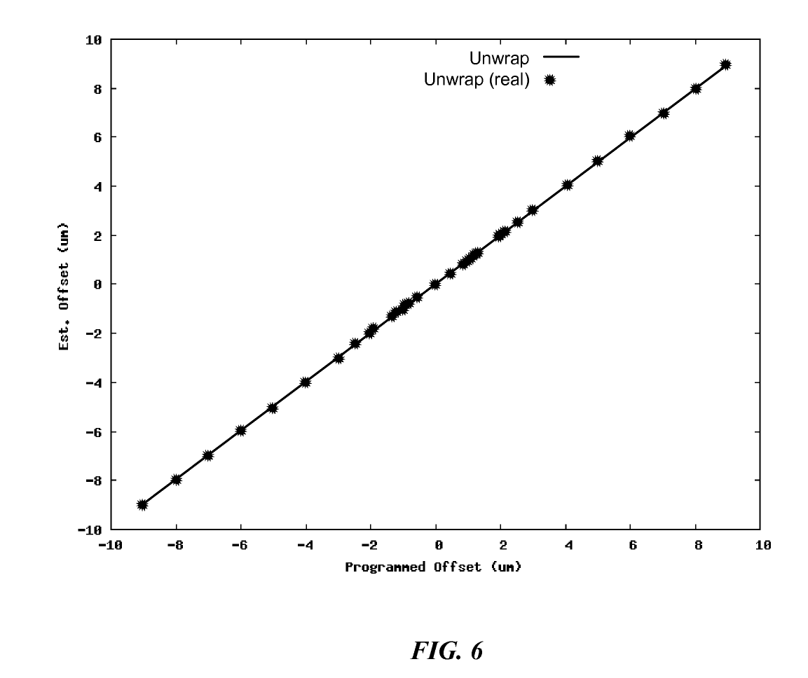

Ideally, delta Δ may be equal to zero. When real data is present, delta Δ may be less than a threshold value T, wherein the threshold value T is generally less than the step in delta Δ that results from a phase wrap. The dataset of FIG. 5 illustrates how the value of delta Δ may be minimized. The result of minimizing delta Δ is the value of displacement error E (shown in FIG. 6) and indicates the true difference is recovered.

The procedure minimizing delta Δ may be iterative wherein an initial direction may be selected and then Ph₁ may be unwrapped with delta Δ redetermined. Additionally, as Ph₂ is unwrapped, delta Δ may be redetermined. This procedure may continue until a maximum number of unwraps is exceeded or delta Δ is less than the threshold T. If delta Δ is greater than the threshold T, then the direction may be changed and the unwrapping steps moved in the opposite direction.

It should be noted that method 100 may be generalized to configurations with three phase values wherein Ph₃ similarly tracks Ph₁. Using this configuration, phase errors introduced by camera rotation may be canceled. Additionally, method 100 may be generalized to configurations wherein Ph₁ and Ph₂ are moving in the same direction. Using this configuration, delta Δ and displacement error E may be swapped.

### Incommensurate Moire Patterns for Template Alignment

Moiré patterns may occur through two semi-transparent gratings having different periods as discussed in further detail in U.S. Publication No. 2004/0189996, which is hereby incorporated by reference.

Incommensurate periods may be used to increase the capture range of a moiré mark. For example, incommensurate period may increase the amount of displacement that may be measured.

Within the prior art, typically two moiré patterns are used to eliminate ambiguity in selecting a unique position during alignment of template 18 with substrate 12. In order to create two moiré patterns, generally four gratings are used, some of which may have the same period and/or different period. As such, the two standard moiré pattern method generally works for a limited range of displacement only as the two moiré patterns may achieve minima at the same moment multiple times if displacement continues. If the periods of moiré patterns are incommensurate, however, a unique position may be determined during alignment of template 18 providing an increase in the capture range. Although the following description provides for two pairs of linear grating, it should be noted, that additional pairs of gratings may used to further increase the capture range.

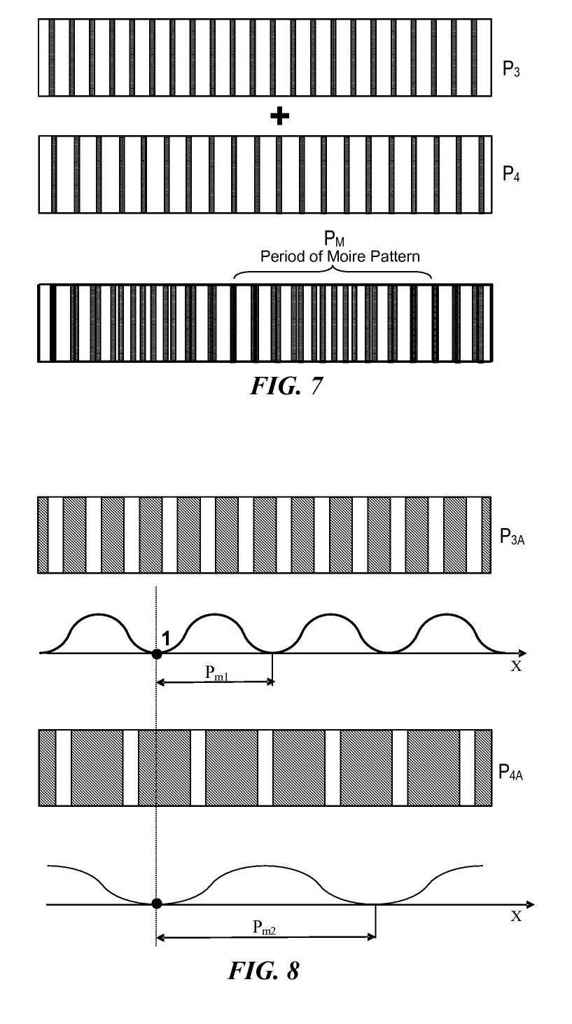

FIG. 7 illustrates two linear gratings with periods P₃ and P₄. Periods P₃ and P₄ form a moiré pattern having period P_{M1}. Generally, the closer the periods P₃ and P₄, the larger the period P_{M1}. Further, two additional linear gratings with period P₅ and P₆ (not shown) form moiré pattern having period P_{M2}.

FIG. 8 illustrates moiré patterns wherein periods Pₘ₁ and Pₘ₂ are incommensurate resulting in patterns defined by:

Pₘ₂≠n(Pₘ₁) (EQ. 7)

wherein n is an integer number. The equivalent positions may be represented by an oscillating function with the minima of two different moiré patterns being at the same location only once as the periods are incommensurate. Incommensurate periods provide a unique position of template 18 and/or substrate 12 at which both periods Pₘ₁ and Pₘ₂ may be aligned to a desired position. This may eliminate ambiguity in selecting the unique position during alignment of template 18. Further, incommensurate periods may be used for automatic alignment of template 18.

What is claimed is:

1. A method to determine relative spatial parameters between two substrates in a process of alignment, said method comprising:
collecting multiple alignment data from phase information provided by an incommensurate moiré based pair of overlaying alignment marks; and,
capturing moiré microscope images by diffracted light from at least one of the alignment marks.

2. The method of claim 1 wherein at least one substrate is a template.

3. The method of claim 2 wherein template is in superimposition with substrate.

4. The method of claim 3 wherein the template is an imprint lithography template for imprinting a pattern in a formable material deposited on substrate.

5. The method of claim 1 wherein spatial parameters include alignment, magnification and distortion parameters.

6. The method of claim 1 further comprising determining displacement from at least one set of phase measurements provided by moiré microscope images.

7. The method of claim 1 wherein each alignment mark comprises at least two gratings.

8. The method of claim 7 wherein the gratings are semi-transparent.

9. The method of claim 7 wherein the gratings are linear gratings.
